(19) United States
(12) Patent Application Publication
(10) Pub. No.: US 2024/0380147 A1
(43) Pub. Date: Nov. 14, 2024

(54) METHOD OF MANUFACTURING CHAIN TERMINAL, CHAIN TERMINAL, AND CONNECTOR

(71) Applicant: YAZAKI CORPORATION, Tokyo (JP)

(72) Inventors: Yuya Kishibata, Makinohara-shi (JP); Naoki Takamura, Makinohara-shi (JP)

(21) Appl. No.: 18/628,683

(22) Filed: Apr. 6, 2024

(30) Foreign Application Priority Data
May 10, 2023 (JP) 2023-077696

(51) Int. Cl. H01R 13/04; H01R 43/16

(52) U.S. Cl. CPC H01R 13/04; H01R 43/16

(57) ABSTRACT

A method of manufacturing a chain terminal includes a process of punching, with pressing, a plurality of terminal sections to be coupled, the step being a press process of simultaneously pressing and punching two terminal sections adjacent to each other among the plurality of terminal sections to be coupled to form a first recess and a second recesses different from each other in the two terminal sections.

### CROSS-REFERENCE TO RELATED APPLICATION(S)

The present application claims priority to and incorporates by reference the entire contents of Japanese Patent Application No. 2023-077696 filed in Japan on May 10, 2023.

### BACKGROUND OF THE INVENTION

### 1. Field of the Invention

The present invention relates to a method of manufacturing a chain terminal, a chain terminal, and a connector.

### 2. Description of the Related Art

There has been known, in relation to a terminal and a connector, for example, as described in Japanese Patent Application Laid-open No. 2007-324049, a connector configured by press-fitting a plurality of terminals (contacts) into a housing. The plurality of terminals are generally manufactured by being separated into individual terminals from a state of a chain terminal coupled by a coupling section (a carrier). The chain terminal is punched into a terminal shape by pressing a sheet metal and is manufactured as the plurality of terminals connected by the coupling section.

The method of manufacturing a chain terminal, the chain terminal, and the connector explained above have room for improvement in that it is difficult to perform the alignment adjustment for the terminals and to improve the productivity of the chain terminal and the connector. For example, in the manufacturing of the chain terminal, the pressing is performed for each one terminal and is sequentially performed for the terminals in a coupling direction. Here, in order to improve the productivity of the chain terminal and the connector, it is conceivable to punch two terminals by one pressing. However, in this case, the two terminals sometimes have different bends and tilts. For example, since the two terminals punched out by pressing are machined in different mold portions, the two terminals are sometimes machined with different inclinations with respect to a set shape. Specifically, in some case, the two terminals are formed to be bent in different directions. In this case, it is difficult to determine which part of a mold should be repaired to perform the alignment adjustment. In particular, when the chain terminal is separated into the terminals and attached to the connector, even if there is a problem with the terminal, it is difficult to specify by which part of the mold the terminal has been machined, and it is difficult to adjust alignment of the terminal by repairing the mold.

Therefore, an object of the present invention is to provide a method of manufacturing a chain terminal, a chain terminal, and a connector that can improve productivity and facilitate alignment adjustment.

### SUMMARY OF THE INVENTION

Therefore, an object of the present invention is to provide a method of manufacturing a chain terminal, a chain terminal, and a connector that can improve productivity and facilitate alignment adjustment.

A method of manufacturing a chain terminal according to one aspect of the present invention, includes a process of punching, with pressing, a plurality of terminal sections to be coupled, the process being a press process of simultaneously pressing and punching two terminal sections adjacent to each other among the plurality of terminal sections to be coupled to form different recesses in the two terminal sections.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a plan view of a chain terminal according to an embodiment;

FIG. 2 is an explanatory diagram of a terminal section in the chain terminal according to the embodiment;

FIG. 3 is a view illustrating a chain terminal in a comparative example;

FIG. 4 is a perspective view of a connector according to the embodiment;

FIG. 5 is a perspective view of a terminal of the connector according to the embodiment;

FIG. 6 is a flowchart illustrating a method of manufacturing a chain terminal according to the embodiment; and

FIG. 7 is an explanatory diagram of a press process in the method of manufacturing a chain terminal according to the embodiment.

### DETAILED DESCRIPTION OF THE PREFERRED EMBODIMENTS

An embodiment according to the present invention is explained in detail below with reference to the drawings. Note that the present invention is not limited by this embodiment. Constituent elements in the embodiment explained below include those that can be easily substituted by those skilled in the art or those that are substantially the same.

### Embodiment

The present embodiment relates to a method of manufacturing a chain terminal, a chain terminal, and a connector. In the following explanation, among a first direction, a second direction, and a third direction intersecting one another, the first direction is referred to as “extending direction X”, the second direction is referred to as “coupling direction Y”, and the third direction is referred to as “height direction Z”. Here, the extending direction X, the coupling direction Y, and the height direction Z are orthogonal to one another. The extending direction X is equivalent to a direction in which a terminal extends. The coupling direction Y is equivalent to a direction in which a plurality of terminal sections are coupled. The coupling direction Y and the height direction Z are equivalent to an orthogonal direction orthogonal to the extending direction X. The directions used in the following explanation represent directions in a state in which sections are assembled to one another unless particularly noted otherwise. Note that the term “orthogonal” as used herein includes “substantially orthogonal”.

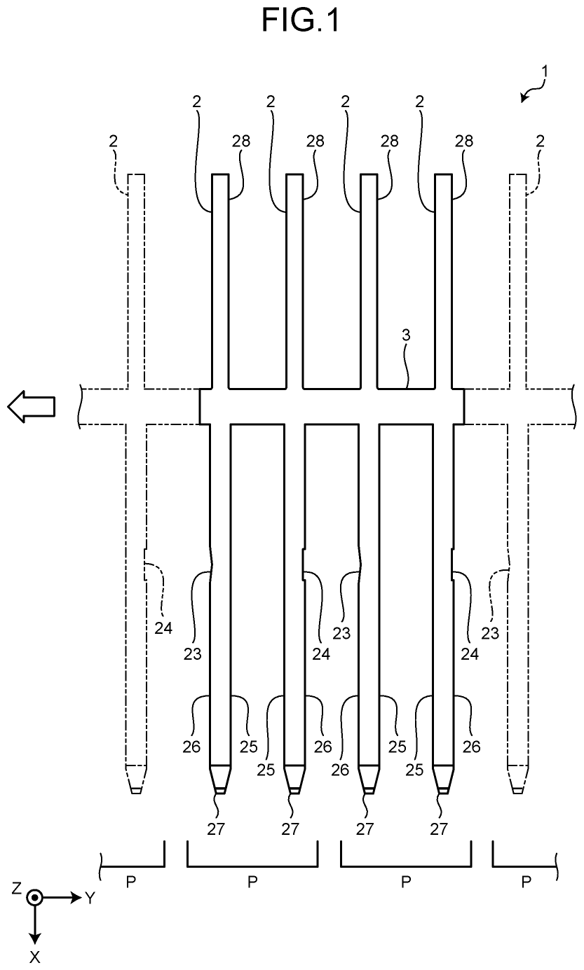

As illustrated in FIG. 1, a chain terminal 1 according to the present embodiment is configured by coupling a plurality of terminal sections 2 with a coupling section 3. FIG. 1 is a plan view illustrating a part of the chain terminal 1 and illustrates a part of the chain terminal 1 configured by connecting a plurality of terminal sections 2 in the coupling direction Y. The chain terminal 1 is made of, for example, conductive metal and is formed by punching a plate-like sheet metal by pressing sheet metal.

The coupling section 3 is a part that couples the plurality of terminal sections 2, extends in the coupling direction Y intersecting the extending direction X of the terminal sections 2, and holds and couples the plurality of terminal sections 2 at predetermined intervals. The coupling section 3 is connected to an intermediate position between both ends of the terminal sections 2.

The terminal sections 2 assume a rod shape and the plurality of the terminal sections 2 are disposed side by side in parallel at predetermined intervals. The terminal sections 2 are provided in the extending direction X and are formed to have the same length in the extending direction X and the same width in the coupling direction Y. The terminal sections 2 have, for example, a rectangular cross-sectional shape in a direction intersecting the extending direction X. In two terminal sections 2 adjacent to each other among the plurality of terminal sections 2, a first recess 23 or a second recess 24 is formed. That is, in the plurality of terminal sections 2, a plurality of first recesses 23 and a plurality of second recesses 24 are alternately formed in the coupling direction Y.

The first recess 23 and the second recess 24 are formed on either inner side surfaces 25 or outer side surfaces 26 of the adjacent two terminal sections 2. That is, the first recess 23 and the second recess 24 are formed only on one of the inner side surfaces 25 and the outer side surfaces 26 of the adjacent two terminal sections 2. The inner side surfaces 25 are inner side surfaces on which the adjacent two terminal sections 2 face and the outer side surfaces 26 are side surfaces opposite to the inner side surfaces 25 in the terminal sections 2. FIG. 1 illustrates a case in which the first recess 23 and the second recess 24 are formed on the outer side surfaces 26 in the adjacent two terminal sections 2. The first recess 23 and the second recess 24 are formed at a predetermined distance from the coupling section 3. For example, the first recess 23 and the second recess 24 are formed at positions closer to the coupling section 3 compared with distal ends 27 of the terminal sections 2.

In the terminal sections 2, besides the first recess 23 and the second recess 24, recesses or projections may be formed on the inner side surfaces 25 and the outer side surfaces 26. For example, in the terminal sections 2, recesses or projections may be symmetrically formed at positions of both of the inner side surfaces 25 and the outer side surfaces 26. Such recesses or projections are different from the first recess 23 and the second recess 24 formed on only one of the inner side surfaces 25 and the outer side surfaces 26 of the terminal sections 2 in that the recesses or the projections are formed on both of the inner side surfaces 25 and the outer side surfaces 26. In the terminal sections 2, the same recesses or protrusions as those of the adjacent terminal sections 2 may be formed. Such recesses or projections are different from the first recess 23 and the second recess 24 formed as different recesses in the adjacent terminal sections 2.

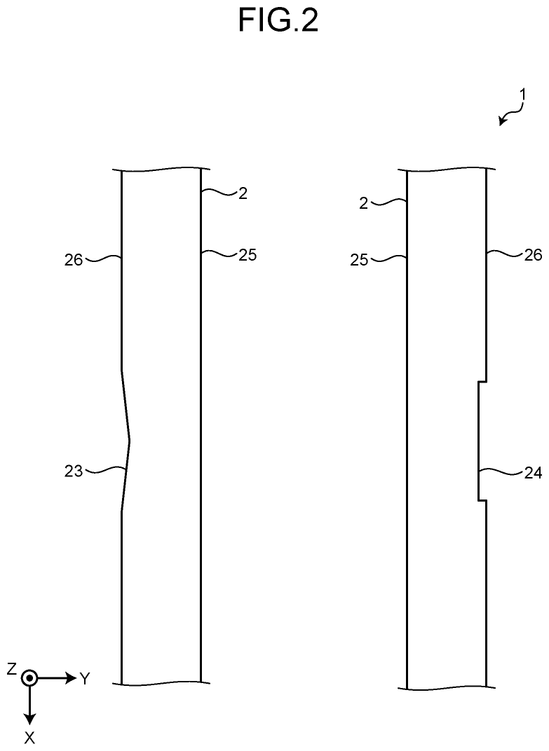

As illustrated in FIG. 2, the first recess 23 and the second recess 24 are formed as different recesses. FIG. 2 illustrates the first recess 23 and the second recess 24 of the adjacent two terminal sections 2 in an enlarged manner. For example, the first recess 23 and the second recess 24 are formed as recesses having different shapes. Specifically, the first recess 23 is a recess formed by hollowing the outer side surface 26 toward the inner side surface 25 in a V shape. The second recess 24 is a recess formed by hollowing the outer side surface 26 toward the inner side surface 25 in a rectangular shape. That is, the second recess 24 is a recess formed by vertically hollowing the outer side surface 26 toward the inner side surface 25 at a fixed width. The first recess 23 and the second recess 24 are formed, for example, as recesses having size and depth enough for enabling the first recess 23 and the second recess 24 to be identified and are formed as recesses that do not impair the function and strength of the terminal section 2. Note that, in FIG. 2, the first recess 23 is the V-shaped recess and the second recess 24 is the rectangular recess. However, if the first recess 23 and the second recess 24 are different recesses, the first recess 23 may be a recess having a shape other than the V-shape and the second recess 24 may be a recess having a shape other than the rectangular shape.

In FIG. 1, by forming the first recess 23 and the second recess 24 which are the different recesses in the adjacent two terminal sections 2, it is possible to identify the terminal section 2 in which the first recess 23 is formed and the terminal section 2 in which the second recess 24 is formed. The first recess 23 and the second recess 24 may be recesses having the same shape if the first recess 23 and the second recess 24 are different recesses. For example, even if the first recess 23 and the second recess 24 have the same shape, the first recess 23 and the second recess 24 may be formed as different recesses by differentiating the lengths of the recesses in the extending direction X, the depths of the recesses in the coupling direction Y, or formation positions of the first recess 23 and the second recess 24.

As explained above, since the first recess 23 and the second recess 24 are formed as different recesses, it is possible to specify by which mold portion the adjacent two terminal sections 2 in which the first recess 23 and the second recess 24 are formed have been pressed. Therefore, when a defect occurs in the terminal section 2, it is possible to grasp which portion of a mold used for the pressing has a problem. Therefore, it is possible to accurately take defect measures by repairing the mold.

In the manufacture of the chain terminal 1, two terminal sections 2 are simultaneously punched out at a time by one pressing P and are sequentially formed in the coupling direction Y. That is, the adjacent two terminal sections 2 in which the first recess 23 and the second recess 24 are formed are simultaneously punched out by one pressing P. The chain terminal 1 can improve productivity by performing so-called two-piece pressing P as compared with when one-piece pressing is performed.

When the two-piece pressing P is performed, for example, the terminal section 2 in which the first recess 23 is formed and the terminal section 2 in which the second recess 24 is formed are formed by different mold portions. The terminal section 2 in which the first recess 23 is formed and the terminal section 2 in which the second recess 24 is formed are formed in the same design shape but is sometimes formed in different shapes, directions, or the like because the terminal sections 2 are formed by the different mold portions. At this time, when one of the terminal sections 2 in which the first recess 23 and the second recess 24 are formed is formed in a shape different from the design shape, by forming the first recess 23 and the second recess 24, which are the different recesses, in the terminal section 2, it is possible to grasp which part of the mold used for the pressing has a problem. Therefore, it is possible to easily and accurately take defect measures by, for example, repairing a pressing device. Therefore, in the chain terminal 1, it is possible to improve productivity while securing the quality of the chain terminal 1 by simultaneously forming the two terminal sections 2 with one pressing.

By forming the first recess 23 and the second recess 24 in the terminal sections 2, it is possible to perform alignment adjustment for the terminal sections 2 at the time of when the pressing is performed. In other words, the first recess 23 and the second recess 24 can be formed to perform the alignment adjustment for the terminal sections 2. For example, when the terminal section 2 is formed to tilt with respect to the extending direction X, the tilt of the terminal section 2 can be suppressed by forming the first recess 23 and the second recess 24 on the side surfaces opposite to the tilting direction.

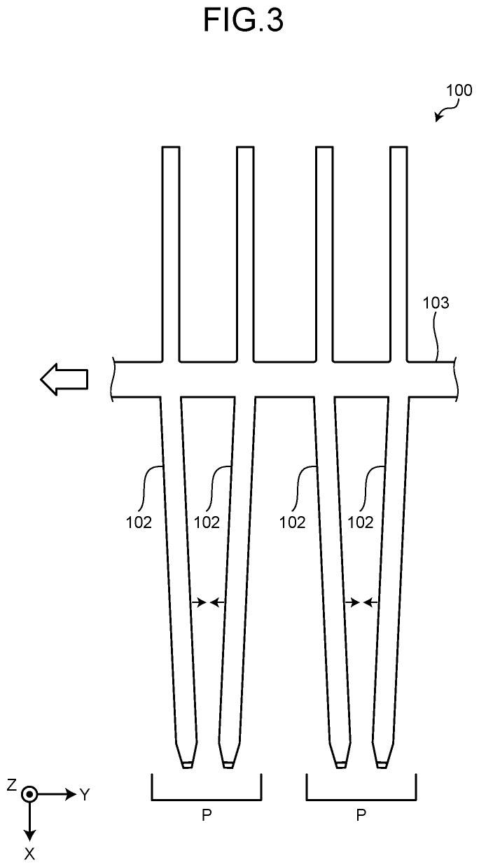

For example, as illustrated in FIG. 3, it is assumed that two terminal sections 102 are simultaneously formed by one pressing for a chain terminal 100 in which the first recess 23 and the second recess 24 are not formed. In this case, the terminal sections 102 simultaneously formed by the pressing P are sometimes formed obliquely to approach each other. That is, the terminal sections 102 are sometimes formed to tilt with respect to the extending direction X and formed to approach each other. In this case, alignment adjustment is necessary such that the terminal section 102 extends in the extending direction X.

Therefore, as illustrated in FIG. 1, in the chain terminal 1 according to the present embodiment, the first recess 23 and the second recess 24 are formed in the two terminal sections 2 that are simultaneously punched by pressing. That is, the first recess 23 and the second recess 24 are formed by hollowing the outer side surfaces 26 on the opposite sides of the inner side surfaces 25 facing each other in the terminal sections 2 simultaneously formed by the pressing P. By forming the first recess 23 and the second recess 24 on the side opposite to the side where the terminal sections 2 tilt in this manner, the two terminal sections 2 are suppressed from being formed to tilt and are properly formed. That is, the pressing P is performed to form the first recess 23 and the second recess 24 on the outer side surfaces 26 of the respective two terminal sections 2, whereby alignment is adjusted such that the two terminal sections 2 are separated from each other, and the two terminal sections 2 are properly formed.

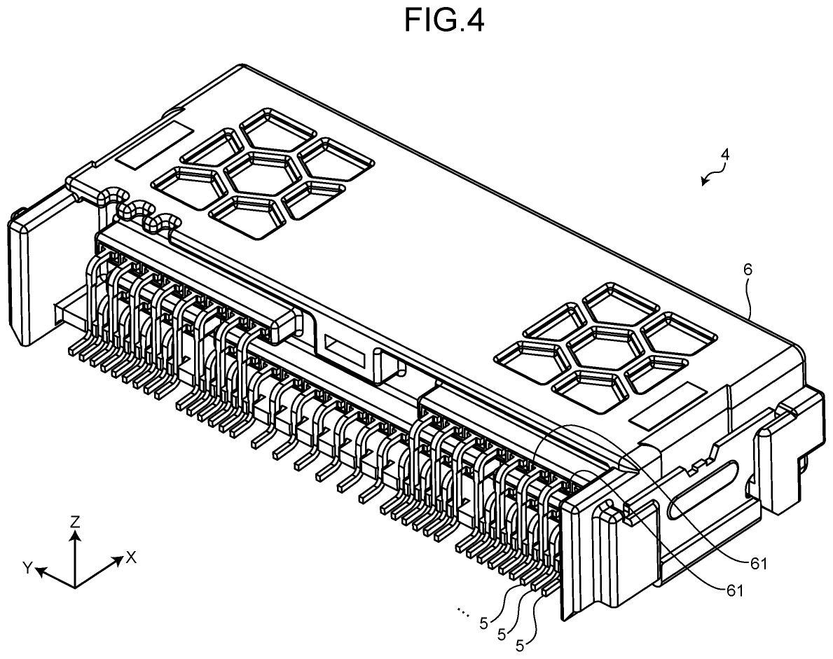

As illustrated in FIG. 4, the connector 4 according to the present embodiment includes a plurality of terminals 5 and a housing 6. The connector 4 is, for example, a connector used by being attached to a printed circuit board. The plurality of terminals 5 are connected to the printed circuit board. The plurality of terminals 5 are attached to the housing 6 and held. The terminal 5 is, for example, press-fitted and attached to an installation hole 61 formed in the housing 6.

The terminal 5 is obtained by separating the plurality of terminal sections 2 of the chain terminal 1 from one another. For example, the chain terminal 1 formed by pressing is plated and thereafter cut and bent for each of the terminal sections 2 to be the plurality of terminals 5. That is, the terminal section 2 is formed as the terminal 5 and is used as one component of the connector 4.

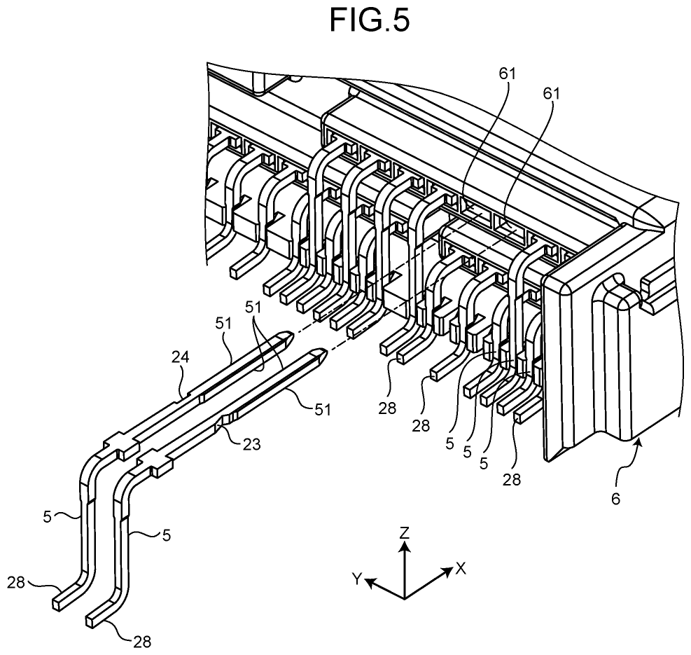

As illustrated in FIG. 5, the plurality of terminals 5 include the terminal 5 in which the first recess 23 is formed and the terminal 5 in which the second recess 24 is formed. That is, the plurality of terminals 5 include the terminal 5 in which the first recess 23 is formed only on one of the side surfaces 51 and 51 on both sides and the terminal 5 in which the second recess 24 is formed only on one of the side surfaces 51 and 51 on both sides. The first recess 23 or the second recess 24 is different from recesses or projections formed symmetrically on both side surfaces on both sides in that the first recess 23 or the second recess 24 is formed only on one side surface of the terminal 5.

The connector 4 is configured by attaching the plurality of terminals 5 to the housing 6. Ends 28 of the terminals 5 are disposed side by side at predetermined intervals. In this state, if the terminals 5 is formed obliquely, the terminals 5 cannot be appropriately connected to a mating connector or printed circuit board. For this reason, when the terminals 5 are formed obliquely with respect to the extending direction X, it is necessary to take defect measures. In this case, the first recess 23 or the second recess 24 is formed in the terminal 5. Therefore, when the terminal 5 in which the first recess 23 is formed tends to have a defect of bending in the same direction, a mold portion that pressed the terminal section 2 in which the first recess 23 is formed only has to be repaired. On the other hand, when the terminal 5 in which the second recess 24 is formed tends to have a defect of bending in the same direction, a mold portion that pressed the terminal section 2 in which the second recess 24 is formed only has to be repaired. By taking such defect measures, the connector 4 is appropriately manufactured while improving productivity.

Next, a method of manufacturing a chain terminal according to the present embodiment is explained.

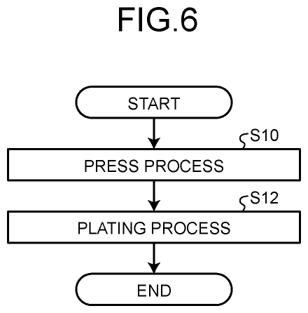

FIG. 6 is a flowchart illustrating the method of manufacturing a chain terminal according to the present embodiment. The flowchart of FIG. 6 may be executed by, for example, a manufacturing device or may be manually executed by an operator.

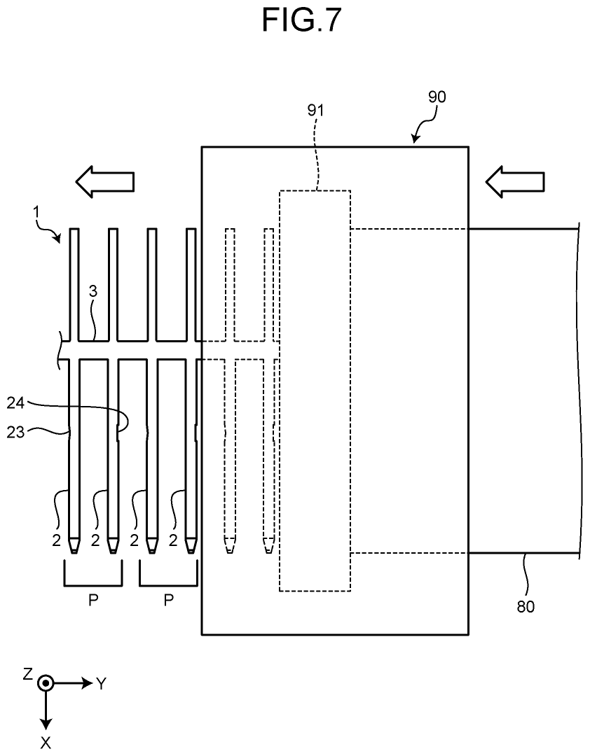

First, in step S10 (hereinafter, simply referred to as “S10”. The same applies to the following steps) of FIG. 6, a press process is performed. The press process is a process of punching, with pressing, the terminal section 2 from a flat plate-shaped metal plate. For example, as illustrated in FIG. 7, in the press process, a metal plate 80 is intermittently sent to a press device 90, the metal plate 80 is punched by a mold 91 to form the chain terminal 1 including the terminal sections 2, and the chain terminal 1 is delivered from the press device 90.

The metal mold 91 is a two-piece metal mold that simultaneously presses the two terminal sections 2 with one pressing. The metal mold 91 includes a metal mold portion that forms the terminal section 2 having the first recess 23 and a metal mold portion the forms the terminal section 2 having the second recess 24. In the press process illustrated in FIG. 7, a case in which the first recess 23 and the second recess 24 are formed by hollowing the outer side surfaces 26 on the opposite sides of the facing inner side surfaces 25 of the adjacent two terminal sections 2 is illustrated. That is, FIG. 7 illustrates a case in which the first recess 23 and the second recess 24 are formed on the respective outer side surfaces 26 in the two terminal sections 2 by one pressing.

When the two terminal sections 2 are simultaneously pressed by one pressing as explained above, by forming the first recess 23 or the second recess 24 on the outer side surfaces 26 of the two terminal sections 2, it is possible to suppress the terminal sections 2 from being formed to tilt with respect to the extending direction X. In addition, when the two terminal sections 2 are simultaneously pressed by one pressing, by forming the first recess 23 or the second recess 24 on the side surfaces of the two terminal sections 2, it is possible to easily grasp by which mold portion the terminal sections 2 and the terminals 5 in which the first recess 23 and the second recess 24 are formed have been formed. Therefore, when there is a defect in the terminal sections 2 or the terminals 5, the metal mold 91 can be quickly and appropriately repaired.

Then, the process shifts to S12 in FIG. 6 and a plating process is performed. The plating process is a process of applying plating to the chain terminal 1 formed in the press process. The plating process is, for example, a process of performing surface treating on the surface of the chain terminal 1 using a plating material such as tin, nickel, or gold. This plating process can be performed using, for example, a publicly-known plating treatment method.

When the plating process in S12 is completed, a series of the manufacturing method illustrated in FIG. 6 is ended. Note that, in the manufactured chain terminal 1, the coupling section 3 between the terminal section 2 and the terminal section 2 is cut and the coupled terminal sections 2 are formed as separate terminal sections 2 and bent to be the terminals 5. The terminals 5 is used as components of the connector 4.

As explained above, the method of manufacturing the chain terminal 1 according to the present embodiment can improve the productivity of the chain terminal 1 by simultaneously pressing and punching the adjacent two terminal sections 2 among a plurality of terminal sections 2 to be coupled. In the method of manufacturing the chain terminal 1 according to the present embodiment, by forming the first recess 23 and second recess 24 different from each other in the two adjacent terminal sections 2, it is possible to easily perform the alignment adjustment for the terminal sections 2 by repairing the mold used in the pressing.

In the method of manufacturing the chain terminal 1 according to the present embodiment, by forming the first recess 23 and the second recess 24 on the outer side surfaces 26 of the adjacent two terminal sections 2 in the press process, it is possible to adjust the alignment of the terminal sections 2 and properly form the terminal sections 2.

In the chain terminal 1 according to the present embodiment, by forming the first recess 23 and the second recess 24 different from each other in the adjacent two terminal sections 2, even when the two terminal sections 2 are simultaneously formed by one pressing, it is possible to identify the terminal section 2 in which the first recess 23 is formed and the terminal section 2 in which the second recess 24. Therefore, it is possible to specify based on the first recess 23 and the second recess 24 by which portion of the mold the terminal sections 2 have been pressed. It is possible to easily perform the alignment adjustment for the terminal section 2 by repairing the mold. Therefore, the chain terminal 1 according to the present embodiment can easily adjust the alignment of the terminal section 2 while improving productivity.

In the chain terminal 1 according to the present embodiment, by alternately forming the first recess 23 and the second recess 24 having the different shapes in the coupling direction Y in the plurality of terminal sections 2, it is possible to easily identify the terminal section 2 in which the first recess 23 is formed and the terminal section 2 in which the second recess 24 is formed.

In the chain terminal 1 according to the present embodiment, the first recess 23 and the second recess 24 are formed to adjust the alignment of the terminal sections 2, Therefore, it is possible to properly form the terminal sections 2 in the extending direction X.

In the connector 4 according to the present embodiment, by using the terminal 5 in which the first recess 23 is formed and the terminal 5 in which the second recess 24 is formed, even when the two terminals 5 are simultaneously formed by one pressing, it is possible to identify the terminal 5 in which the first recess 23 is formed and the terminal 5 in which the second recess 24. Therefore, it is possible to specify based on the first recess 23 and the second recess 24 by which portion of the mold the terminals 5 have been pressed. It is possible to easily perform the alignment adjustment for the terminal 5 by repairing the mold. Therefore, in the connector 4 according to the present embodiment, it is possible to achieve improvement of productivity and easily adjust the alignment of the terminal 5.

Note that the method of manufacturing a chain terminal, the chain terminal, and the connector according to the present invention are not limited to the embodiment explained above and various changes are possible within the scope described in the claims. The method of manufacturing a chain terminal, the chain terminal, and the connector according to the present embodiment may be configured by combining the constituent elements of the embodiments and the modifications explained above as appropriate.

With the method of manufacturing a chain terminal, the chain terminal, and the connector according to the present embodiment, it is possible to improve productivity and facilitate alignment adjustment.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A method of manufacturing a chain terminal, comprising:
a process of punching, with pressing, a plurality of terminal sections to be coupled, the process being a press process of simultaneously pressing and punching two terminal sections adjacent to each other among the plurality of terminal sections to be coupled to form different recesses in the two terminal sections.

2. The method of manufacturing the chain terminal according to claim 1, wherein
in the press process, outer side surfaces on opposite side of inner side surfaces facing each other of the adjacent two terminal sections are hollowed to form the different recesses.

3. A chain terminal comprising:
a plurality of terminal sections; and
a coupling section that connects the plurality of terminal sections in a direction intersecting an extending direction of the terminal sections, wherein
in two terminal sections adjacent to each other among the plurality of terminal sections, different recesses are formed on one of inner side surfaces facing each other and outer side surfaces on opposite sides of the inner side surfaces.

4. The chain terminal according to claim 3, wherein
in the plurality of terminal sections, recesses having different shapes are alternately formed in a coupling direction.

5. The chain terminal according to claim 3, wherein
the recess is formed to adjust alignment of the terminal sections.

6. The chain terminal according to claim 4, wherein
the recess is formed to adjust alignment of the terminal sections.

7. A connector comprising:
a plurality of terminals including a terminal in which a first recess is formed on one of side surfaces on both sides and a terminal in which a second recess different from the first recess is formed on one of the side surfaces; and
a housing to which the plurality of terminals are attached.
